(19) United States
(12) Patent Application Publication
(10) Pub. No.: US 2012/0153607 A1
(43) Pub. Date: Jun. 21, 2012

(54) SECURITY ELEMENT FOR AN ARTICLE TO BE PROTECTED AND ARTICLE TO BE PROTECTED WITH SUCH A SECURITY ELEMENT

(75) Inventors: Michael Rahm, Bad Toelz (DE); Wittich Kaule, Emmering (DE); Manfred Heim, Bad Toelz (DE); Andreas Rauch, Ohlstadt (DE); Josef Schinabeck, Gmund (DE); André Gregarek, Muenchen (DE); Angelika Hilgenrainer, Miesbach (DE)

(73) Assignee: GIESECKE & DEVRIENT GMBH, Muenchen (DE)

(21) Appl. No.: 13/387,661

(22) PCT Filed: Jul. 15, 2010
(86) PCT No.: PCT/EP2010/060249

§ 371 Date: Feb. 24, 2012

(30) Foreign Application Priority Data
Jul. 30, 2009 (DE) 102009035361.5

(51) Int. Cl. B42D 15/10; B32B 3/30

(52) U.S. Cl. 283/94; 428/166; 283/109

(57) ABSTRACT

The invention relates to a security element for an article to be protected, having an upper face and a lower face, one or more imaging optical arrangements, which all image a respective associated object to a magnified scale only in front of the upper face, wherein the one optical arrangement or at least one of the optical arrangements comprises a plurality of reflective micro-imaging elements arranged two-dimensionally in a first pattern, and the associated object is in the form of a microstructure object having a plurality of microstructures, which are arranged in a microstructure pattern so matched to the first pattern that the microstructure object is imaged to a magnified scale in front of the upper face by means of the reflective micro-imaging elements. On both its upper face and its lower face the security element has an adhesive layer (14, 16), with which the security element can be embedded in the article to be protected such that both the upper face and the lower face are adhesively secured to the article to be protected.

The invention relates to a security element for an article to be protected, such as for example security papers, value documents or the like, as well as an article to be protected with such a security element.

Articles to be protected are often provided with a security element which allows the authenticity of the article to be checked and/or serves as protection against unauthorized reproduction.

Articles to be protected are for example security papers, identity and value documents (such as for example banknotes, smart cards, passports, identity cards, identification cards, shares, bonds, certificates, coupons, cheques, admission tickets, credit cards, health insurance cards, etc.) as well as product security elements, such as for example labels, seals and packaging.

If the security element is in the form for example of a security thread for a banknote and has for example a plurality of microlenses for imaging a security feature to a magnified scale, the problem arises that the surface of the thread cannot be provided with adhesive on the lens face, which is why the paper webs spanning the thread once it is embedded in the paper of the banknote are not connected to the thread and therefore an undesired lifting-off (or looping) of these webs from the security thread can occur. This results in a reduction of the circulation durability of the banknote.

Starting from this, the object of the invention is to provide a security element for an article to be protected with which the problems mentioned at the beginning can be solved. An article to be protected with such a security element is also to be made available.

According to the invention, the object is achieved by a security element for an article to be protected, having an upper face and a lower face, one or more imaging optical arrangements, which all image a respective associated object to a magnified scale only in front of the upper face, wherein the one optical arrangement or at least one of the optical arrangements comprises a plurality of reflective micro-imaging elements arranged two-dimensionally in a first pattern, and the associated object is in the form of a microstructure object having a plurality of microstructures, which are arranged in a microstructure pattern so matched to the first pattern that the microstructure object is imaged to a magnified scale in front of the upper face by means of the reflective micro-imaging elements, and wherein on both its upper face and its lower face the security element has an adhesive layer, with which the security element can be embedded in the article to be protected such that both the upper face and the lower face are adhesively secured to the article to be protected.

Because reflective imaging elements are used, the rear faces of these reflective micro-imaging elements, as well as the microstructures spaced apart from them or the layer carrying them, can be provided with the adhesive layers or layers of adhesive, with the result that the security element can be glued for example into a banknote by both of its faces. The undesired lifting-off of the webs between the windows which are provided in the banknote in order to make the imaging to a magnified scale possible is thus avoided.

Micro-imaging elements are preferably in the form of micro-concave mirrors which have a reduced focal length compared with refractive microlenses, with the result that the thickness of the security element (for example the thread thickness) can be considerably reduced. Thicknesses of less than 30 μm can be achieved.

In particular, the micro-imaging elements can be arranged on one side of a film and the microstructures on the other side of the film. The film can in particular be in the form of a transparent film, for example a PET film. A simple manner of producing the security element with simultaneously excellent alignment of the reflective micro-imaging elements with the microstructures is thus possible.

In particular, the micro-imaging elements lie in a first plane and the microstructures in a second plane parallel to the first plane. The distance between the two planes can correspond to the focal length of the micro-imaging elements. A very compact structure of the security element according to the invention is thus possible.

At least one of the adhesive layers or the layers of adhesive can be in the form of a heat seal lacquer layer. Both adhesive layers or in particular the adhesive layer on the upper face of the security element are transparent, wherein by transparent is preferably meant here a transmittance of at least 10% and in particular of at least 50%. The layer of adhesive under the reflective micro-imaging elements can also be designed non-transparent, preferably white, in order to reduce the extent to which the thread shows through the rear face of the banknote (rear-face sheet).

The security element according to the invention is preferably formed here such that all optical arrangements of the security element can image the object allocated to them to a magnified scale always only in front of the upper face.

Known microstructuring methods, such as for example embossing methods, can be used to generate the micro-imaging elements as well as the microstructures. Thus, for example suitable structures can be illuminated, optionally improved, moulded in resist materials, using methods known from semiconductor manufacture (photolithography, electron beam lithography, laser lithography, etc.), and used to produce embossing tools. The known methods for embossing in thermoplastic films or in films coated with radiation-curing lacquers are particularly suitable for the production of large surface areas.

The security element can be in the form in particular of security threads, tear-off threads, security band, security strips, patch or a label for embedding into the article to be protected.

The dimensions of the micro-imaging elements are preferably chosen such that they lie below the resolving power of the human eye. In particular, the dimensions can lie in a range of from 3 μm to 80 μm, preferably from 3 μm to 50 μm and particularly preferably from 3 μm to 30 μm.

The first pattern as well as the microstructure pattern can be in the form of a hexagonal grid or also a polygonal grid, such as for example a rectangular or parallelogram-shaped grid.

An article to be protected having a front face in which at least one window is formed is furthermore provided, wherein a security element according to the invention is embedded in the article to be protected such that it is arranged at least in the area of the window and with its upper face turned towards the window, wherein both the upper face and the lower face of the security element are adhesively secured to the article by means of the adhesive layers.

A high durability can be guaranteed by adhesively securing both sides of the security element in the article to be protected. If, for example, the article to be protected is in the form of a banknote and the security element in the form of an embedded security thread, an undesired lifting-off of the webs between the windows can be avoided.

The one optical arrangement, one of the optical arrangements or also several of the optical arrangements of the security element can lie in the area of the window.

With the article to be protected, the window can be sealed with a transparent cover. This leads to a further increase in the durability of the article to be protected.

The article to be protected is preferably formed substantially two-dimensionally. In particular, the article to be protected can be in the form of a security paper, value document or the like.

By security paper is meant here in particular, in addition to the security element according to the invention, the not yet negotiable precursor for a value document which for example can also have further authenticity features (such as for example luminescent substances provided therein). By value documents are meant here, on the one hand, documents produced from security papers. On the other hand, value documents can also be other documents or articles which can be provided with the security feature according to the invention, in order that the value documents have authenticity features that cannot be copied, whereby it is possible to check their authenticity and at the same time undesired copies are prevented.

The substrate of a security paper or value document particularly preferably consists of paper made of cotton fibres, such as is used for example for banknotes. Preferably, the substrate can also consist of paper from other natural fibres, also preferably from synthetic fibres, i.e. a mixture of natural and synthetic fibres or also preferably of at least one plastic film.

A security paper, such as is described in DE 102 43 653 A9, the disclosure of which is incorporated into this invention in full in this respect, results from a coating or lamination on both sides of the substrate with in each case at least one plastic film. In this case, the security element according to the invention is applied to the substrate before the coating or lamination on both sides is applied to the substrate. The security element according to the invention is thus advantageously embedded in the security paper.

It is understood that the features mentioned above and those yet to be explained in the following are applicable, not only in the stated combinations, but also in other combinations or singly, without departure from the scope of the present invention.

The invention is explained in further detail below by way of example using the attached drawings which also disclose features essential to the invention. There are shown in:

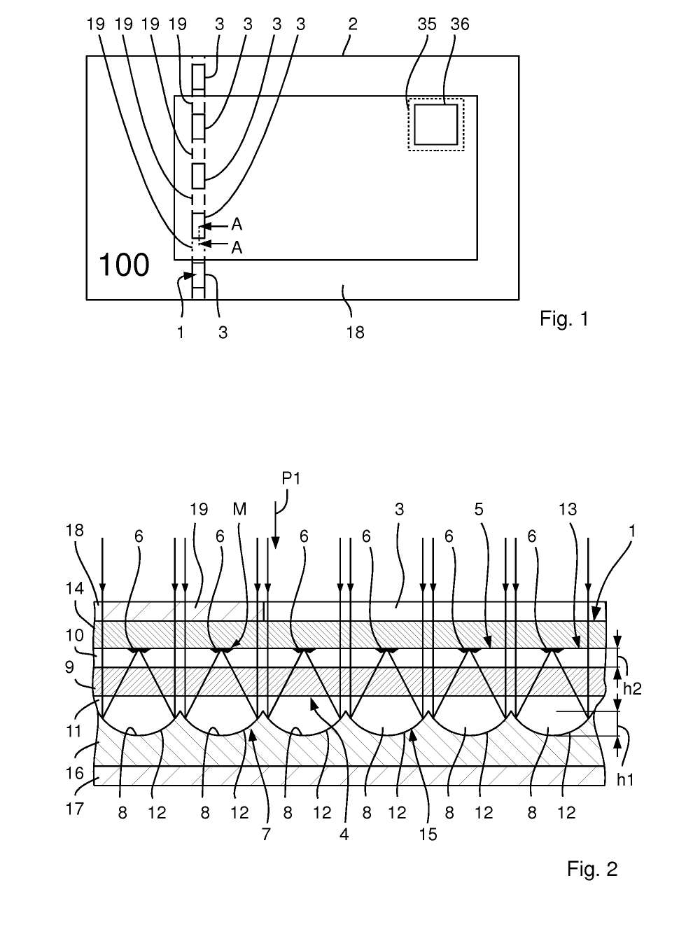

FIG. 1 a top view of a banknote 2 with a security element 1 according to the invention;

FIG. 2 a magnified view of the section along line A-A in FIG. 1;

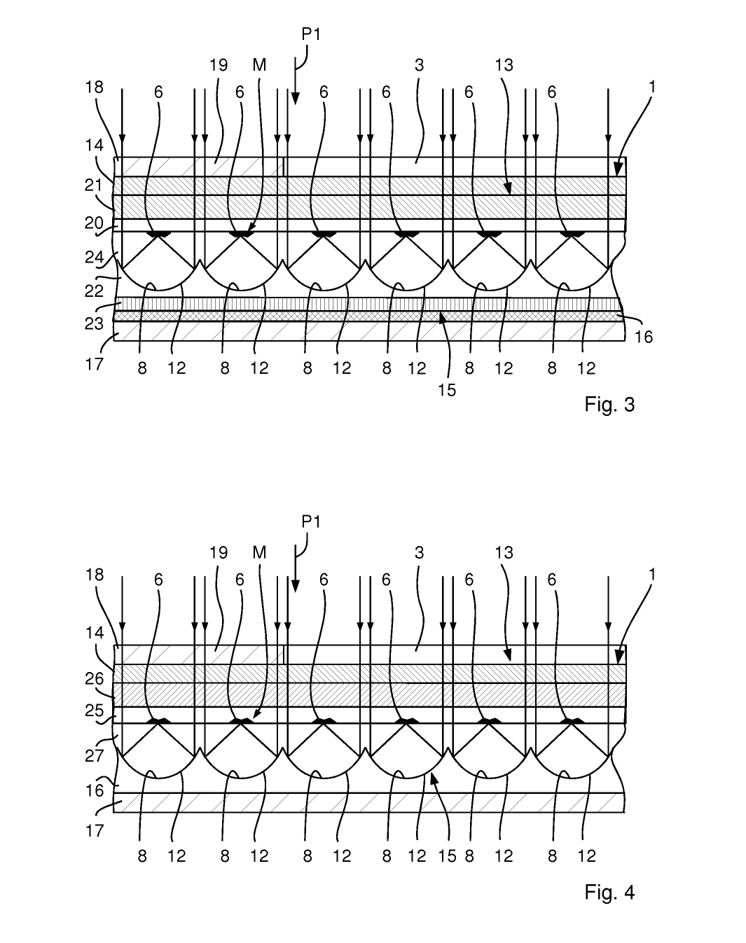

FIG. 3 a further embodiment of the security element 1 according to the invention in a sectional view according to FIG. 2;

FIG. 4 a further embodiment of the security element 1 according to the invention in a sectional view according to FIG. 2;

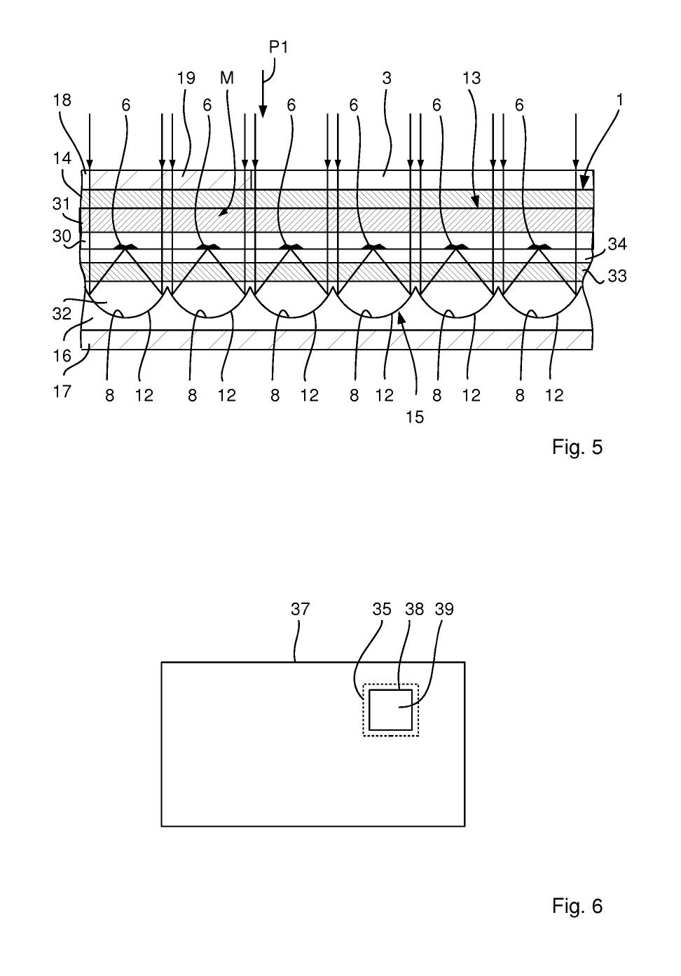

FIG. 5 a further embodiment of the security element 1 according to the invention in a sectional view according to FIG. 2, and

FIG. 6 a top view of a smart card 37 with a security element 35 according to the invention.

In the embodiment shown in FIG. 1, the security element 1 according to the invention is in the form of a security thread and integrated into an article 2 to be protected (here banknote 2) such that the security thread is exposed, or is not covered by the banknote, in window areas 3 spaced apart from each other, as recesses in the upper face of the banknote are formed in the window areas 3, with the result that there is a free view of the security thread 1.

As can be seen from the sectional representation in FIG. 2, which shows, to a magnified scale, a part of the embedded security element 1 along the section line A-A from FIG. 1, the security element 1 comprises a carrier 4 which has microstructures 6 on its first face 5 and several micro-concave mirrors 8 on its opposite second face 7.

The sectional view of FIG. 2 and all further sectional views of further embodiments of the security element 1 according to the invention are not represented to scale, for better presentability. Furthermore, hatchings are sometimes not drawn in, in order to be able to represent the structure of the corresponding security element 1 more clearly.

The micro-concave mirrors 8 are arranged in a plane perpendicular to the plane of drawing of FIG. 2 in a grid with fixed geometry (here for example a hexagonal grid) and thus two-dimensionally in a first pattern.

The microstructures 6 which form a microstructure object or image M are also arranged in a plane perpendicular to the plane of drawing of FIG. 2 in a grid with fixed geometry (here for example a hexagonal grid) and thus two-dimensionally in a microstructure pattern, wherein the microstructure pattern is adjusted to the first pattern and both patterns are aligned with each other such that when the security element is viewed through the window areas 3 (direction of the arrow P1) the microstructures 6, together with the micro-concave mirror 8, form a modulo magnification arrangement. The basic principle of such a modulo magnification arrangement is described for example in WO 2009/000528 A1, the whole content of which is hereby incorporated, wherein the microstructure object M of the present invention corresponds to the motif image according to the teaching of WO 2009/000528 A1.

Thus, looking in the direction of the arrow P1, the microstructure object M can be perceived, to a magnified scale, by a viewer in the respective window area 3 as a security feature (as desired image within the meaning of WO 2009/000528 A1). This is for example the letter P.

Naturally, it is also possible to match the microstructure pattern of the microstructures 6 and the first pattern of the micro-concave mirrors 8 to each other such that there is a Moiré magnification arrangement. The basic principle of a Moiré magnification arrangement is described for example in WO 2006/087138 A1, the whole content of which is hereby incorporated.

With the structure shown in FIG. 2, the carrier 4 comprises a PET film 9 to which a first layer 10 of radiation-curing lacquer (for example UV lacquer), which has the microstructures 6, is applied. The microstructures 6 can be produced in known manner, for example by embossing into the UV lacquer 10 followed by printing-on and wipe-off of ink. Certain ink transfer methods or micro-gravure techniques which are described for example in PCT/EP2008/010739 or WO 2008/000350 and the disclosure content of which is incorporated to this extent in the present application can be used as further colouring methods.

A second layer 11 of radiation-curing lacquer (for example UV lacquer) in which the female mould of the micro-concave mirrors 8 is embossed is formed on the lower face of the PET film 9. To produce the micro-concave mirrors 8, the face of the second layer turned away from the PET film 9 is coated with a reflective coating 12 (e.g. a metallization). The micro-concave mirrors 8 are thus in the form of rear surface mirrors.

A reflective coating 12 in the form of a metallization has the advantage that it is electrically conductive and magnetizable. Additionally, an ink with magnetic pigments which has a continuously unchanging magnetization or one that is different in different partial sections can also be hidden under the reflective coating 12. The security element according to the invention thus has the additional security features of electrical conductivity and magnetic coding.

The inside of the reflective coating 12 of each micro-concave mirror 8 or the embossed mould for the micro-concave mirrors 8 here has the form of a spherical cap with a radius of curvature of 38 μm and a height h1 of approximately 3.1 μm. The maximum thickness of the second layer 11 (from the apex of a micro-concave mirror 8 to the PET film 9) here is approximately 5.1 μm, the PET film has a thickness of 12 μm and the height h2 of the first layer 10 is 2 μm.

As the radius of curvature of the micro-concave mirrors 8 is 38 μm, the micro-concave mirrors 8 have a focal length of 19 μm. Because of the described structure, the microstructures 6 are at a distance of approximately 19 μm from the micro-concave mirrors 8 and thus lie in the same plane as the focal points of the micro-concave mirrors 8, with the result that the desired imaging to a magnified scale of the microstructures 6 of the security feature is brought about. The face of the first layer 10 turned away from the micro-concave mirrors 8 is the upper face 13 of the security element 1, to which a first adhesive layer 14 of heat seal lacquer is applied. Furthermore, the rear face of the micro-concave mirrors 8, and thus the reflective coating 12, forms the lower face 15 of the security element 1. A second adhesive layer 16 (here again a heat seal lacquer layer) is applied to the lower face 15. Because of the use of micro-concave mirrors 8, it is thus possible with the security element 1 according to the invention to form an adhesive layer 14, 16 respectively on both the upper face 13 and the lower face 15.

The second adhesive layer 16 serves to adhesively secure the security element 1 to a rear-face sheet 17 of the banknote 2, as shown in FIG. 2. The first adhesive layer 14 serves to join the security element 1 to a front-face sheet 18 of the banknote 2, wherein here in particular the webs 19 of the front-face sheet 18 are adhesively secured to the security element 1 between the window areas 3, with the result that an undesired lifting-off of these webs 19 from the security element 1 can be prevented. Thus, the security element 1 is introduced into the banknote 2 and an imaging, to a magnified scale, of the security feature now takes place in front of the upper face 13 or in front of the front-face sheet 18.

In the representation in FIG. 1, the width of the security thread 1 (extent from left to right in FIG. 1) is equal to the width of the window areas 3. Naturally, it is possible to choose a larger width for the security thread 1, with the result that an adhesive securing to the front-face sheet 18 is also possible alongside the window areas 3 by means of the first adhesive layer 14.

The micro-concave mirrors 8 with the associated microstructures 6 which lie in front of one of the window areas 3 can be described as an optical arrangement which images, to a magnified scale, the microstructure object M (the object associated with the micro-concave mirrors 8) in front of the upper face 13. Thus, the micro-concave mirrors 8 and the microstructures 6 in front of each window area 3 can be described as a separate optical arrangement, with the result that the security thread 1 has several optical arrangements. Naturally, all micro-concave mirrors 8 and all microstructures 6 can also be seen as belonging to a single optical arrangement. However, it is furthermore possible to provide several optical arrangements per window area 3. It is essential here that all optical arrangements image the respective object, to a magnified scale, always only in front of the upper face 13.

In a variant, not shown, of the security element 1 of FIG. 2, the microstructures 6 on the one hand and the micro-concave mirrors 8 on the other hand are embossed on two separate films (e.g. PET films) and provided with a metallization or with ink. These two films are then joined together in a structure according to FIG. 2, with the result that two laminated PET films are present instead of the PET film 9 shown in FIG. 2. Should the distance between the micro-concave mirrors 8 and the microstructures 6 be altered by this structure, the curvature of the micro-concave mirrors 8 would have to be adjusted such that the microstructures 6 in the assembled state again lie in the focal points of the micro-concave mirrors 8. The distance substantially depends, naturally, on the thickness of the two PET films as well as the quantity of the adhesive needed for the lamination.

It may be pointed out that the dimensions of the already described embodiments and of the embodiments to follow are to be understood only by way of example. Other values can result depending on e.g. the materials and pattern sizes used.

An embodiment of the security element 1 according to the invention when embedded in the banknote 2, which can be called lamination variant, is shown in FIG. 3. In this variant, the microstructures 6 and the micro-concave mirrors 8 are first manufactured separately. The microstructures 6 are formed on a UV lacquer layer 20 which is applied to a first carrier film 21. In the same way, the micro-concave mirrors 8 are formed in a UV lacquer layer 22 (by embossing and metallization) which is applied to a second carrier film 23. The two carrier films 21 and 23 are preferably PET films. The thus-formed microstructures 6 and micro-concave mirrors 8 are laminated together, wherein the micro-concave mirrors 8 and the microstructures 6 are turned towards each other, as can be seen in FIG. 3. There is only the laminating adhesive 24 between them.

However, it is also possible to provide one or more additional lacquer layers (not shown) between the micro-concave mirrors 8 and the microstructures 6, in order to set a desired distance.

A first adhesive layer 14 is again formed on the upper face 13 of the thus-formed security element 1 and a second adhesive layer 16 on the lower face 15 of the security element 1, with which the security element 1 is adhesively secured to the front- and rear-face sheets 18, 17 of the banknote 2.

In the embodiment of FIG. 3, the carrier films 21 and 23 offer the internal microstructures 6 as well as the internal micro-concave mirrors 8 excellent protection against environmental influences and assaults by potential counterfeiters. Also shown in the embodiment of FIG. 3 is a structure in which it is not necessary to place a film as a spacer between the microstructures 6 and the micro-concave mirrors 8.

A further embodiment of the security element 1 according to the invention when embedded in the banknote, which can be produced as follows, is shown in FIG. 4.

Firstly, microstructures 6 are embossed in a first UV lacquer layer 25 which is applied to a PET film 26 and coloured using a suitable method. A second UV lacquer layer 27 is then applied to the embossed UV lacquer layer 25 and the moulds for the micro-concave mirrors 8 which are then formed by evaporation deposition with a metal layer 12 are produced in a second embossing.

The second adhesive layer 16 is then applied to the thus-formed micro-concave mirrors 8. Alternatively, a protective lacquer layer, not shown, to which the second adhesive layer 16 is then applied can first be formed on the micro-concave mirrors 8. The first adhesive layer 14 is again applied to the upper face 13 (the face of the PET film 26 turned away from the micro-concave mirrors 8) of the security element 1. An adhesive securing or fixing of the security element 1 in the banknote 2 can be carried out with the two adhesive layers 14 and 16.

In a variant, not shown, the PET film 26 can be formed such that it can be detached from the UV lacquer layer 25. In this case, the second adhesive layer is applied directly to the UV lacquer layer 25 after the PET film 26 is detached.

A further embodiment of the security element 1 according to the invention which is inserted in the banknote 2 is shown in FIG. 5. In this embodiment, the microstructures 6 and the micro-concave mirrors 8 are first produced separately from each other. For this, the microstructures 6 are embossed into a UV lacquer layer 30 which is formed on a PET film 31 and then coloured. In a separate work step, the micro-concave mirrors (or their female mould) are embossed into a UV lacquer layer 32 which is applied to a PET film 33. The embossed moulds for the micro-concave mirrors 8 are given a reflective coating either now or after the lamination.

The PET film 33 is then laminated together with the UV lacquer layer 30 (laminating adhesive 34), wherein the quantity of the laminating adhesive 34 applied is set such that the Moiré- or modulo-magnified images (thus here the microstructure object) are to be sharply seen.

The first and second adhesive layer 14, 16 is again formed on the upper and lower face 13, 15, in order to adhesively secure the security element 1 to the front- and rear-face sheets 18, 17 of the banknote 2 in the described manner.

The PET film 31 can again be detachably joined to the UV lacquer layer 30. In this case, the first adhesive layer 14 is applied directly to the UV lacquer layer 30.

The security element 1 according to FIG. 5 can also be produced by the following work steps. Firstly, the UV lacquer layer 30 is embossed and coloured, in order to produce the microstructures 6. The PET film 33 is then laminated onto the UV lacquer layer 30. The UV lacquer layer 32 is formed on the laminated-on PET film 33 and the micro-concave mirrors 8 are formed in this UV lacquer layer 32 by embossing and coating.

Through this procedure, it is advantageously achieved that the PET film 31 brings about an additional strength of the structure during the embossing of the micro-concave mirrors 8, which is of great importance having regard to the effect of even small distortions on the visual appearance during the Moiré or modulo magnification.

The security element 1 according to the invention can be in the form e.g. of a security element 35 with a rectangular shape such that it lies in the window area 36 of the front-face sheet 18 of the banknote 2. In this case, the security element 35 is preferably larger than the window area 36, as indicated in FIG. 1 by the dotted outline, with the result that an adhesive securing of the security element 35 to the front-face sheet 18 is possible by means of the first adhesive layer 14.

In particular when embedding the security element 36 into a smart card 37 (as an example of a value document), the window area 38 can, as indicated in FIG. 6, have a transparent cover 39 to which the security element 35 is adhesively secured by means of the first adhesive layer. A long-lasting embedding of the security element 35 is thus achieved.

Naturally, such a transparent cover can also be present in the banknote 2 according to FIG. 1. Thus, the banknote can be in the form e.g. of a composite film banknote in which both the front- and the rear-face sheet 17, 18 are formed multi-layered, wherein the respectively outermost layer is transparent and the window areas 3 are formed in the layer below it with the front-face sheet 18.

Micro-concave mirrors 8 were described in each of the above embodiments. It is understood that the micro-concave mirrors are given as representatives of reflective micro-imaging elements. In particular, it is possible to use diffractive elements as reflective imaging elements, if they realize the desired imaging properties (in the same or a similar way to the micro-concave mirrors 8).

The micro-imaging elements can be formed with a circular or polygonally delimited base surface in particular by micro-concave mirrors or also by elongated cylindrical micro-concave mirrors the extent of which in longitudinal direction is more than 250 μm, preferably more than 300 μm, particularly preferably more than 500 μm and in particular more than 1 mm. Furthermore, mirrors, Fresnel mirrors, zone mirrors or other elements with reflecting action are possible as micro-imaging elements. The micro-concave mirrors 8 can have a spherical curvature or else an aspherical curvature.

The reflective coating 12 of the micro-concave mirrors 8 can be realized e.g. by means of an applied metal layer (for example vapour-deposited). Typically, an aluminium layer with a thickness of e.g. 50 nm is applied. Naturally, other metals, such as e.g. silver, copper, chromium, iron, etc. or alloys thereof can also be used. The combination of several metals on and/or next to each other is also possible, e.g. an evaporation deposition with Cu area by area followed by an evaporation deposition with aluminium over the whole surface area. As an alternative to the metal, highly refractive coatings can also be applied, for example MgF₂, ZnS or TiO₂. When a suitable thickness is chosen, the reflecting action can additionally be increased by interference effects. For ZnS, the appropriate layer thickness is for example approximately 60 nm. A thin-layer system of for example alternately high- and low-refractive layers can also be applied such that the sequence of layers acts as a reflector. Such layer systems can be tailored to a specific wavelength.

The reflective coating 12 can be over the whole surface area of the individual micro-concave mirrors 8. However, it is also possible to carry out a coating only over area by area or in grid form, with the result that the micro-concave mirrors 8 are semitransparent. The thickness of the coating can also be chosen such that, instead of a complete reflective coating, there is a semitransparent reflective coating.

By a semitransparent reflective coating is meant here in particular a reflective coating in which the transmittance averaged over at least one micro-concave mirror lies in the range of from 10% to 90%.

The reflective coating can furthermore be realized as a colour-shifting coating which has e.g. a layer system of absorber, dielectric and reflector. The colour-shifting face of the layer system can be turned towards or away from the microstructures 6. In the first case, the colour generated by the layer system can be adapted to the colour of the microstructures 6.

Furthermore, it is possible to bring about an effect of colour-shifting to both sides with the layer system if e.g. a sequence of layers of absorber, dielectric, reflector, dielectric and absorber is applied. The described colour-shifting layer systems can also be applied over the whole surface area or only in area by area.

The security element 1 can have still further security features, such as for example holograms, cleartext or other known security features which are described for example on page 18 of the description of WO 2009/000528 A1.

1-10. (canceled)

11. A security element for an article to be protected, comprising:
an upper face and a lower face; and
one or more imaging optical arrangements, which all image a respective associated object to a magnified scale only in front of the upper face,
wherein at least one of the optical arrangements comprises a plurality of reflective micro-imaging elements arranged two-dimensionally in a first pattern, and the associated object comprises a microstructure object having a plurality of microstructures, which are arranged in a microstructure pattern so matched to the first pattern that the microstructure object is imaged to a magnified scale in front of the upper face by the reflective micro-imaging elements, and
wherein on both the upper face and the lower face of the security element each include an adhesive layer, with which the security element can be embedded in the article to be protected such that both the upper face and the lower face are adhesively secured to the article to be protected.

12. The security element according to claim 11, wherein the micro-imaging elements comprise micro-concave mirrors.

13. The security element according to claim 12, in which the micro-imaging elements are arranged on one side of a film and the microstructures on an opposing side of the film.

14. The security element according to claim 12, wherein the micro-imaging elements lie in a first plane and the microstructures lie in a second plane parallel to the first plane.

15. The security element according to claim 14, wherein the micro-imaging elements have a focal length and the distance between the two planes corresponds to the focal length of the micro-imaging elements.

16. The security element according to claim 11, wherein the micro-imaging elements lie in a first plane and the microstructures lie in a second plane parallel to the first plane.

17. The security element according to claim 16, wherein the micro-imaging elements have a focal length and the distance between the first and second planes corresponds to the focal length of the micro-imaging elements.

18. The security element according to claim 11, wherein the micro-imaging elements are arranged on one side of a film and the microstructures on an opposing side of the film.

19. The security element according to claim 11, in which at least one of the adhesive layers is in the form of a heat seal lacquer layer.

20. The security element according to claim 11, wherein at least one of the adhesive layers comprises a heat seal lacquer layer.

21. An article to be protected, comprising:
a front face in which at least one window is formed; and
a security element embedded in the article such that it is arranged at least in the area of the window and with its upper face turned towards the window, wherein both the upper face and the lower face of the security element are adhesively secured to the article by the adhesive layers; the security element comprising:
an upper face and a lower face; and
one or more imaging optical arrangements, which all image a respective associated object to a magnified scale only in front of the upper face,
wherein at least one of the optical arrangements comprises a plurality of reflective micro-imaging elements arranged two-dimensionally in a first pattern, and the associated object comprises a microstructure object having a plurality of microstructures, which are arranged in a microstructure pattern so matched to the first pattern that the microstructure object is imaged to a magnified scale in front of the upper face by the reflective micro-imaging elements, and
wherein on both the upper face and the lower face of the security element each include an adhesive layer, with which the security element can be embedded in the article to be protected such that both the upper face and the lower face are adhesively secured to the article to be protected.

22. The article according to claim 21, wherein the window is sealed with a transparent cover.

23. The article according to claim 22, wherein the article is formed substantially two-dimensionally.

24. Article according to claim 23, in which the article is in the form of a security paper, value document or the like.

25. Article according to claim 22, in which the article is in the form of a security paper, value document or the like.

26. Article according to claim 21, in which the article is in the form of a security paper, value document or the like.

27. The article according to claim 21, wherein the article is formed substantially two-dimensionally.

28. The article according to claim 27, in which the article is in the form of a security paper, value document or the like.

29. An article to be protected, comprising:
a front face in which at least one window is formed; and
a security element embedded in the article such that it is arranged at least in the area of the window and with its upper face turned towards the window, wherein both the upper face and the lower face of the security element are adhesively secured to the article by the adhesive layers; the security element comprising:
an upper face and a lower face; and
one or more imaging optical arrangements, which all image a respective associated object to a magnified scale only in front of the upper face,
wherein at least one of the optical arrangements comprises a plurality of reflective micro-imaging elements arranged two-dimensionally in a first pattern, and the associated object comprises a microstructure object having a plurality of microstructures, which are arranged in a microstructure pattern so matched to the first pattern that the microstructure object is imaged to a magnified scale in front of the upper face by the reflective micro-imaging elements,
wherein on both the upper face and the lower face of the security element each include an adhesive layer, with which the security element can be embedded in the article to be protected such that both the upper face and the lower face are adhesively secured to the article to be protected, and
wherein the micro-imaging elements comprise micro-concave mirrors.

30. The article according to claim 29, wherein the micro-imaging elements lie in a first plane and the microstructures lie in a second plane parallel to the first plane.
